(19) United States
(12) Patent Application Publication
(10) Pub. No.: US 2024/0334133 A1
(43) Pub. Date: Oct. 3, 2024

(54) Tone Detection in Hearing Device Audio Signals

(71) Applicant: Eargo, Inc., San Jose, CA (US)

(72) Inventors: Brenton Steele, Blackburn South (AU); Bryant E. Sorensen, State College, PA (US)

(21) Appl. No.: 18/285,946

(22) PCT Filed: Apr. 23, 2021
(86) PCT No.: PCT/US2021/028989

§ 371 Date: Oct. 6, 2023

(51) Int. Cl. H04R 25/00

(52) U.S. Cl. CPC H04R 25/453; H04R 2225/023

(57) ABSTRACT

Methods, devices and systems for signal processing an audio signal in a hearing device to determine whether the signal is tonal. The signal is converted at each of a series of successive time windows into samples in the frequency domain across multiple subbands. For at least one of the subbands, a normalized cross-correlation is calculated between two different samples in the same subband. A metric resulting from the calculation is compared to a predetermined threshold to provide a measure of whether the signal is tonal. The signal is considered to be tonal in the frequency of the subband when the metric is greater than or equal to the predetermined threshold, and the signal is considered to be not tonal in the frequency of the subband when the metric is less than the predetermined threshold.

### CROSS-REFERENCE

This application International Application No. PCT/US2021/028989, filed Apr. 23, 2021. PCT/US2021/028989 is hereby incorporated herein, in its entirety, by reference thereto and to which application we claim priority under 35 USC § 119.

### FIELD OF THE INVENTION

This disclosure relates to detection of whether an audio signal in an acoustic system is tonal. More particularly this disclosure relates to detection of whether an audio signal in a hearing device is tonal.

### BACKGROUND OF THE INVENTION

A hearing device typically includes a microphone, a speaker and an amplifier configured to amplify sound received in the form of a signal from the microphone to an amplified signal that is output from the speaker as a sound that is amplified relative to the amplitude of the sound inputted to the microphone. One or more processors may be provided not only to control the amplifier, but to further process the signal. One such further process involves cancellation of feedback that may exist in the signal. Examples of hearing devices include, but are not limited to: headsets, hearing aids, public address systems, telephones, radios, cochlear implants, bone conduction devices and personal listening devices.

A related task that may be carried out by a processor is performed to identify whether the input signal is tonal or not. This determination is especially useful for improving the performance of a feedback cancellation algorithm within a hearing device.

Hearing aid devices are designed to provide gain to amplify sounds to compensate for a user's hearing loss. However, because there is an acoustic path from the speaker of the hearing aid back to the microphone, there is a high risk of instability. This instability may present as a disturbing howling or squealing sound, sometimes referred to as feedback. This instability needs to be removed or controlled if the device is to be comfortably used by a user for an acceptable user experience. This howling is very tonal.

Typically, a system approach is used to control this howling. An example system in a hearing aid has two parts. One part is an adaptive feedback canceller, which continuously models the acoustic path and attempts to cancel the feedback signal coupling from the hearing aid output back into the microphone. Another part is a suppression system that reduces the forward gain when feedback audio artifacts arise, to control transient howling due to movement or handling, and to compensate for slow adaption of the feedback canceller.

An important aspect of a system is to be able to detect the tonal nature of a howl or feedback. Although a tone detector, by itself, does not distinguish between tonal sounds in the environment (such music, beeps, alarms, etc.) and howls caused by feedback, the detection of tones is important for early identification and suppression of feedback, as once a tone is detected, it can be further evaluated, such as by the feedback cancellation system, to determine whether the tone is feedback or a sound in the environment.

Many different approaches have been taken in attempting to reduce the susceptibility of hearing devices, such as hearing aids to feedback. For example, attenuation and notch filtering have been employed in U.S. Pat. No. 4,088,835; and detection of an exponential rise in a periodic signal for early identification of feedback in U.S. Pat. No. 8,942,398.

U.S. Pat. No. 10,097,930 discloses methods for tonality-driven feedback canceler adaptation in which the method includes strength of tonality that is determined by estimating a second derivative of a subband phase of an input signal.

U.S. Pat. No. 7,302,070 discloses a method for identifying oscillation in a signal due to feedback, in which a change in signal phase is calculated for each of a plurality of frequency bands generated by an FFT device from a series of successive time windows of an audio signal to produce a measure of whether oscillation due to feedback is present in the signal. Systems such as these typically require calculations such as arctangent, which are difficult to perform on an embedded fixed-point digital signal processing (DSP) platform.

There is a need in the art for improved methods and systems for detecting tones of an audio signal of a hearing device to allow rapid and efficient detection of tones so that they can be further evaluated and processed to determine whether they are from the sound environment or from feedback. When they are from feedback they can be processed and reduced or eliminated by a feedback cancellation system.

There is a need in the art for more efficient methods and systems for detecting tones of an audio signal of a hearing device, which can be more readily carried out on relatively limited processors that may be provided with some types of hearing devices.

There is a need in the art for more efficient methods and systems for detecting tones of an audio signal of a hearing device, which can reduce the cost (and potentially the size) of tone detection and feedback cancellation systems of hearing devices.

### SUMMARY OF THE INVENTION

According to an embodiment of the present invention, a method of signal processing an audio signal in a hearing device to determine whether the signal is tonal includes: converting the signal at each of a series of successive time windows into samples in the frequency domain across multiple subbands; calculating for at least one of the subbands a normalized cross-correlation between two different samples in the same subband; and comparing a metric resulting from the calculating to a predetermined threshold to provide a measure of whether the signal is tonal; wherein the signal is considered to be tonal in the frequency of the subband when the metric is greater than or equal to the predetermined threshold and the signal is considered to be not tonal in the frequency of the subband when the metric is less than the predetermined threshold.

In at least one embodiment, the calculating and comparing are performed for each of a plurality of the multiple subbands.

In at least one embodiment, the calculating and comparing are performed for all of the multiple subbands.

In at least one embodiment, the calculating step is iterated for successive samples, and the comparing step is performed relative to an average of the results from the iterated calculation steps.

In at least one embodiment, there is no time overlap corresponding to the two different samples in the frequency or joint time-frequency domain.

In at least one embodiment, the method further includes improving processing efficiency of the calculating step by using at least one of count sign bits (CSB), count leading bits (CLB) or log 2 approximation of absolute value.

In at least one embodiment, when a signal is considered to be tonal, the method further includes: reducing a gain of the signal in the subband where the tonal signal is considered to be.

In at least one embodiment, when a signal is considered to be tonal, the method further includes: providing the tonal signal to a feedback cancellation system configured to determine whether the tonal signal is feedback.

In at least one embodiment, the hearing device is a hearing aid.

In at least one embodiment, the hearing aid is a completely-in-the-canal (CIC) hearing aid.

According to an aspect of the present invention, a hearing device is provided that includes: a microphone; a receiver; and a processor connected to the microphone and the receiver, the processor configured to receive an audio signal from the microphone and process the audio signal and the receiver configured to provide an output signal to a user, the processor further configured to: convert the signal at each of a series of successive time windows into samples in the frequency domain across multiple subbands; calculate for at least one of the subbands a normalized cross-correlation between two different samples in the same subband; and compare a metric resulting from the calculation of the normalized cross-correlation to a predetermined threshold to provide a measure of whether the signal is tonal; wherein the signal is considered to be tonal in the frequency of the subband when the metric is greater than or equal to the predetermined threshold and the signal is considered to be not tonal in the frequency of the subband when the metric is less than the predetermined threshold.

In at least one embodiment, the hearing device is a hearing aid.

In at least one embodiment, the hearing aid is a completely-in-the-canal (CIC) hearing aid.

In at least one embodiment, when a signal is considered to be tonal, the signal is provided for further processing to determine whether the tonal signal is feedback; and when the tonal signal is determined to be feedback, reduce a gain of the signal in the subband where the tonal signal is considered to be.

In at least one embodiment, when a signal is considered to be tonal, the signal is provided for further processing to determine whether the tonal signal is feedback, so that when the tonal signal is determined to be feedback, the feedback can be addressed by a feedback cancellation system to cancel the feedback.

In at least one embodiment, the processor is configured to perform the calculate and compare steps for each of a plurality of the multiple subbands.

In at least one embodiment, the processor is configured to perform the calculate and compare steps for all of the multiple subbands.

In at least one embodiment, the calculate step is iterated for successive samples, and the compare step is performed relative to an average of the results from the iterated calculation steps.

In at least one embodiment, the processor is configured to improve processing efficiency of the calculate step by using at least one of count sign bits (CSB), count leading bits (CLB) or log₂ approximation of absolute value.

According to an aspect of the present invention, a hearing device includes: a microphone; a receiver; and a processor connected to the microphone and the receiver, the processor configured to receive an audio signal from the microphone and process the audio signal and the receiver configured to provide an output signal to a user, the processor further configured to: convert the signal at each of a series of successive time windows into samples in the frequency domain across multiple subbands; compare a pair of samples in the frequency domain in a same one of the subbands to calculate a normalized cross-correlation; calculate a metric based on the normalize cross correlation and compare the metric to a predetermined threshold to provide a measure of whether the signal is tonal; wherein the signal is considered to be tonal in the frequency of the subband when the metric is greater than or equal to the predetermined threshold and the signal is considered to be not tonal in the frequency of the subband when the metric is less than the predetermined threshold.

These and other advantages and features of the invention will become apparent to those persons skilled in the art upon reading the details of the methods and devices as more fully described below.

### BRIEF DESCRIPTION OF THE DRAWINGS

Various embodiments of the present invention are illustrated by way of example in the figures of the accompanying drawings. Such embodiments are demonstrative of the present invention and are not intended to be limiting as to the only embodiments possible, as the invention is defined by the appended claims, as supported by the specification and drawings.

FIG. 1 illustrates an acoustic system 100 that uses Weighted Overlap Add (WOLA) architecture for signal processing in a hearing device configured to perform tone detection according to an embodiment of the present invention.

FIG. 2 illustrates a generalized example of a completely in the canal (CIC) ear hearing aid installed in the ear canal of a user, which may employ a tone detector according to an embodiment of the present invention.

FIG. 3A shows complex results calculated from WOLA block pairs over ten different time intervals for a particular subband, according to an embodiment of the present invention, where the frequency of the signal being processed is relatively close to the subband frequency center.

FIG. 3B shows complex results calculated from WOLA block pairs over ten different time intervals for the same subband as in FIG. 3A, but where the frequency of the signal being processed is relatively further away from the subband frequency center, relative to the signal being process in FIG. 3A.

FIG. 4A shows that each of the plotted complex correlation results (calculated according to an embodiment of the present invention) has about the same phase value, (around 45° in this example) indicating that the signal being analyzed is a tone.

FIG. 4B shows that the plotted complex correlation results (calculated according to an embodiment of the present invention) have greatly varying phase angles, indicating that the signal being analyzed is not a tone.

FIG. 5 is a flow diagram illustrating events that may be carried out during processing of a signal to detect whether there is tonality, according to an embodiment of the present invention.

FIG. 6 plots the response of the tone detector to a stimulus (signal) in an example performed using a tone detector according to an embodiment of the present invention.

FIGS. 7A-7I plot response of the tone detector in response to various stimuli, which vary by the signal-to-noise ratios of the tone to white noise employed in each of the examples, using a tone detector according to an embodiment of the present invention.

### DETAILED DESCRIPTION OF THE INVENTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a signal” includes a plurality of such signals and reference to “the subband” includes reference to one or more subbands and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

An “audio processing system” as used herein is a system that includes a microphone and a receiver or speaker, an adaptive feedback canceler for removing feedback, as well as processing electronics for amplification of signals. Examples of audio processing systems include, but are not limited to: listening devices, hearing aids, telephony, public address systems, headsets, audio conference systems, etc.

The terms “tonality” “tonal signal”, “tonal input” “tone” and “tonal”, as used herein refer to audio signals that are larger in signals that are dominated by single-frequency components having slowly varying (or non-varying) frequencies (tones), and smaller in signals that are not comprised of such components.

The terms “bins”, “channels”, “frequency bins” and “binned signals”, as used herein, refer to subbands of a signal resulting from splitting the signal from the time domain to frequency domain, or to the joint time-frequency domain. A bin is an interval in the frequency domain, delimited by a lower frequency and an upper frequency wherein each bin (i.e., subband) is characterized by a different frequency range than the other resulting bins. The terms “bin” or “bins” are used interchangeably with the terms “channel” and “subband”; equivalently the plural terms “bins” or “channels” and “subbands” are also interchangeable herein.

The multiple outputs of each WOLA computation are referred to as subbands or bins, each representing the estimated frequency content of the latest set of time domain samples. There are M subbands (or M bins), each full bin of which contains 1 new complex frequency domain sample (from which magnitude and phase can be computed) for every WOLA computation. Note that the first and last bins may have only half the bandwidth of the other bins and contain only real (not complex frequency domain) data. These half bandwidth bins are therefore not further processed for tone detection, as they don't contain information pertaining to phase that can be analyzed.

“Joint Time-Frequency Analysis”, as used herein, refers to calculations on time-domain data which produce frequency segmentation of the data, but which also advance in time for each calculation.

A “WOLA frame” or “WOLA block” refers to N time-domain samples which are processed together with older time-domain samples using WOLA computations to form 1 frequency-domain (actually joint time-frequency) sample across M frequency bins, wherein N and M are positive integers greater than 1.

A “WOLA analysis frame”, as used herein, refers to P WOLA blocks that are concatenated to form the WOLA analysis frame, where P is a positive integer greater than 1. This WOLA analysis frame includes a WOLA frame or WOLA block of the latest N time-domain samples, along with ((P−1)*N) previous time domain samples, for the total of (P−1)*N+N=P*N time domain samples.

A “WOLA sample”, as used herein, refers to one of the M bins of a WOLA computation (that has been performed on a WOLA analysis frame).

The term “entrainment” as used herein refers to an occurrence when a feedback canceller mistakenly attempts to cancel a tonal input to an audio processing system. This results in the addition of a tone to the original input signal to the audio processing system, especially when the tonal input then goes away.

The term “feedback”, as used herein, refers to the reflection of the output signal back into the input, in a recursive manner, such that the audio processing system goes unstable at some frequency. It is also referred to as ‘positive loop gain’ which includes an acoustic path from the output signal back to the input signal, and the signal processing within the audio processing system.

Hearing devices may be provided with a feedback cancellation system such as an adaptive feedback canceller which continuously monitors the audio signal from the devices' input, and adapts to the feedback signal in that input to provide anti-phase cancellation. When properly functioning, these devices tend to settle to a quiescent state where the feedback path is cancelled. However, one of the causes of feedback that can result in howling is input characterized as tonal. By providing a system that can readily identify tonal signals, this can improve the efficiency and rapidity with which a system can adapt to and suppress feedback. The present invention provides tone detection capability for hearing devices that can detect the presence of tones, which can then be further evaluated as to whether they are resultant from environmental sounds, or from feedback. When they are determined to be feedback, further processing can be carried out to suppress or cancel the feedback.

Entrainment artifacts in audio systems include squealing or howling sounds that can be very annoying to the listener. As noted, such entrainment artifacts may occur with input sounds such as music, tonal parts of speech, beeps, alarms, rings, clicks, pops, etc. Such entrainment artifacts can occur when the input and output signal are strongly self-correlated, which can occur with the examples provided above, as well as others. Self-correlated signals are self-similar over a short time span, that is, similar to slightly delayed versions of themselves. If the signal is similar to a delayed version of itself, then at the hearing aid input, the feedback canceler cannot distinguish new signal from feedback. The simplest case of this self-similarity is a tonal or pitched signal. A periodic signal is identical to versions of itself delayed by the pitch period, and thus tonal signals, like music, are troublesome for adaptive feedback cancelers.

Suppression systems require several parts to detect feedback howling. However, an important aspect is to be able to detect the tonal nature of a howl. The present invention provides a tone detector and an implementation of the tone detector that can be used in a howl suppression system. The tone detector, by itself, does not distinguish between tonal sounds in the environment (such as music) and howls caused by feedback. Other parts of the system are used to differentiate between these stimuli.

This disclosure describes an invention to do the tone detection portion, in a subband processing hearing device, such as a hearing aid system or other hearing device.

The present invention discloses, among other things, apparatus and methods for signal processing an input signal in a hearing device to detect when a signal is tonal or includes tones so that a feedback canceler can be notified when a tone is detected, to further process the signal to determine whether the tone is feedback or results from an environmental sound. If feedback is determined, the feedback can then be mitigated by the feedback cancelation subsystem. If the tone is determined to not be feedback, but rather the result of an environmental sound, the feedback cancelation system will not address the tone.

The present invention increases overall sound quality and/or improves feedback cancellation performance by proactively detecting when the input signal is tonal, and addressing the tone when it is feedback so as to remove or mitigate it, while ignoring the tone when it is determined that the tone is not feedback. Thus the present invention facilitates early mitigation of entrainment in adaptive feedback cancellation while minimizing degradation of the hearing device output, thereby improving sound quality for tonal inputs such as speech and music and other inputs susceptible to entrainment, as described above.

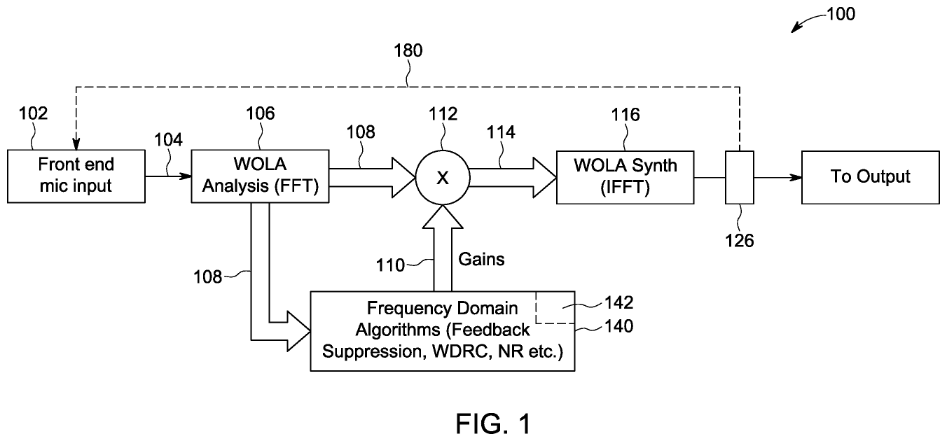

FIG. 1 illustrates an acoustic system 100 that uses Weighted Overlap Add (WOLA) architecture for signal processing in a hearing device and is provided with a subsystem 140 including at least one processor 142 configured to perform tone detection according to an embodiment of the present invention. Subsystem 140 may additionally be configured (or, alternatively one or more additional subsystems may be provided which are configured) to perform additional signal processing, such as further analyzing a signal that has determined to contain a tone by the present invention, to determine whether the tone is feedback or from an environmental source, application of gain to the signal, adaptive feedback cancellation, noise reduction, etc. for tones determined to be feedback. At the front end of the system, an audio input is provided such as through a microphone 102, for example. The audio input is digitized (e.g., using an analog-to-digital converter) into a sequence of digital audio samples and the digital audio samples are split into a plurality of subband signals. The audio input signal 104 may processed, for example, by WOLA (weighted, overlap add) method by 106 to break the signal up into frequency bins. Architecture 106 uses a Fast Fourier Transform (FFT) to apply a filter bank for joint time-frequency analysis (also referred to as the “frequency domain”). This is also referred to as WOLA analysis. The splitting of the input time-domain signal into frequency bins can alternatively be accomplished by other means, including but not limited to a Short-Time Fourier Transform (STFT), In at least one example the signal is broken into thirty-three frequency bins. However, this is not limiting, as more or fewer bins could be made from splitting/breaking up the signal 104. The dual parallel lines in the FIG. 1 illustrate frequency domain signals and the single lines represent time domain signals. The operations on the frequency domain signals may be performed on all the bins in parallel. Although typically all bins having complex frequency domain samples are processed to detect whether or not tonality is present, it would be possible to process only a subset of the bins for the same. For example, where a range of possible feedback frequencies is known to be less that the full range of the WOLA analysis, then only a subset of the bins may need to be processed. Other situations may also give rise to the need to process less than all bins to provide satisfactory monitoring. Further, serial processing of the bins is possible, but is less efficient, so that parallel processing as described is preferred.

The subband signals 108 are processed for tone detection separately (although typically in a parallel), as described in the following. Cross-correlation calculations per subband are performed by processor 142 of subsystem 140. Processing includes calculation of a normalized cross-correlation between samples of the same frequency bin at different times. Multiple such calculations can be made by iterating this step for successive samples and an average cross-correlation value over multiple samples can be computed from the multiple cross-correlation values. The average cross-correlation value can be approximated by introducing a smoothing factor to the normalized cross-correlation value. A metric used to detect whether a signal is tonal is then calculated as the magnitude (absolute value) of the smoothed, normalized cross-correlation. The metric can then be compared to a threshold value to decide whether a tone is present.

Note that the bins (input in the subband domain) 108 generated at 106 result from processing signal 104 which includes both environmental sounds picked up by the microphone 102 as well as feedback sound that is fed back to the microphone 102 from the receiver/speaker 126 along feedback path 180.

If the metrics calculated by the processor, when compared to the threshold value, indicate that no tone is present, then the subsystem 140 will not make any changes to the adaptive feedback canceler that would be applied to mitigate a tone. The subsystem 140 may perform other functions, such as gain application, noise reduction, etc. 110, to be applied to signal 108 at 112. If on the other hand, a tone is detected, then the feedback canceler of the subsystem 140 will further process the bin or bins in which the tone was detected. A feedback cancellation subsystem such as that described in copending U.S. application Ser. No. 17/239,427 filed Apr. 23, 2021 and titled Detection of Feedback path Change (which is incorporated herein, in its entirety, by reference thereto), or other known feedback cancellation subsystem may be used for further processing to determine whether the detected tone is from an environmental sound, or from feedback. If the tone is determined to be from an environmental sound, again the feedback cancellation subsystem does not make any changes to its feedback suppression settings. If the tone is determined to be feedback, the subsystem 140 may decrease the gain in the frequency(ies) of the bin(s) where tone was detected. Additionally, or alternatively, an adaptation rate of the feedback canceler may be increased so as to more rapidly mitigate the feedback due to the tone. The adaptation rate change could be applied to a subset (less than all of the bins) where feedback is determined to occur, or, alternatively, could be applied to all the bins.

The processed signal subbands 114 resulting from combination of the gain signal 110 from subsystem 140 with the subbands 108 at 112 are further processed using an inverse FFT (IFFT) to perform WOLA synthesis at 116, which returns the signal to the time domain for output through receiver/speaker 126. As noted, while in the joint time-frequency domain, there is processing to allow gain to be applied in the frequency domain, as well as feedback cancellation and noise reduction, among others.

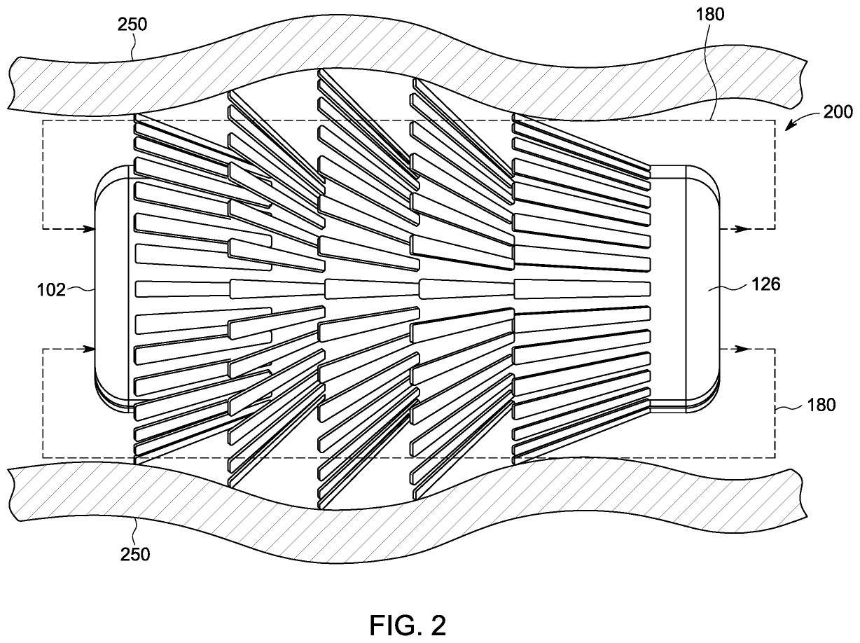

FIG. 2 illustrates a generalized example of a completely in the canal (CIC) ear hearing aid 200 installed in the ear canal 250 of a user. The hearing aid 200 includes an input device 102, such as a microphone positioned in the ear canal to receive sounds coming from the opening in the ear canal 250 that leads outside of the user. An output device 126, such as a receiver of the hearing aid is positioned to deliver sound toward the ear drum at the opposite end of the ear canal 250. Sounds picked up by the microphone 102 are processed and transmitted as audio signals by receiver 126. As noted previously, feedback paths 180 are provided by the gaps or open-air spaces between the hearing aid 200 and the walls of the ear canal 250, so that sound can travel from the receiver 126, through the gaps and to the microphone 102.

The audio input at 106 in FIG. 1 is processed using WOLA frequency analysis to decimate frames of time-domain microphone audio, and separate them into multiple frequency bands. These frequency bands are also known as subbands or bins, since the frequency of the audio frames is broken down into subbands, each having a subset of the entire frequency range of the band. Generally N samples of time-domain data are combined into a ‘block’ (called a “WOLA block” here), which is concatenated with additional WOLA blocks to make a WOLA analysis frame that is used to calculate data, across M frequencies or subbands. In one non-limiting example, N=8 samples of time domain data produces 1 WOLA block of WOLA-domain data across M=33 frequency bins, wherein bins 1-31 contain complex frequency domain samples and bins 0 and 32 contain real data. The next N=8 samples of time domain data are then collected, the processing is repeated, and another WOLA block is again generated across M=33 subbands. However subband 0 and subband 32 are half bands and do not contain complex frequency domain sample, but are real. Therefore only subbands 1-31 are further processed to detect tone occurrence. Hence, 1 time step in WOLA domain is equivalent to 8 time steps (samples) in the time domain in this specific example, or more generally, 1 WOLA block is generated by N time samples, where N is an integer greater than one. A WOLA block is then N=8 time domain samples. The block sampling rate may be 0.5 ms, although this could also be lesser or greater, for example, block sizes of 0.1 ms to 10 ms may be used. It may be possible to use block sizes less than 0.1 ms or greater than 10 ms.

The complex results within each frequency subband represent the magnitude and phase in the frequency subband at a given point in time. These complex-valued results created for each WOLA block of data can be analyzed over time to detect the presence of a tone.

The present invention provides a tone detector that is fast, efficient and provides greater applicability to hearing devices than those known heretofore. Detection of tones is carried out by analysis of WOLA samples from WOLA subbands. Advantageously, the present invention does not calculate the phase of the input signal directly and therefore avoids the need for processor intensive calculations such as calculations of arctangent. The present invention calculates the normalized cross-correlation, per bin, between a WOLA sample (sample of frequency bin) of a WOLA analysis frame at the current time and a WOLA sample from an older WOLA analysis frame in the same frequency bin. That is, each calculation of normalized cross-correlation is calculated from the complex time-frequency of a WOLA sample from a WOLA analysis frame at one particular time, which typically includes the most recent WOLA block received and a WOLA sample of the same frequency bin from a complex time-frequency WOLA analysis frame from another particular time span, which is typically a WOLA analysis frame from an earlier time that does not include the most recent WOLA block. The calculation performs a complex multiplication, followed by the division of the product by its magnitude, as noted in equation 1:

$$\text{?} ( f ) = \frac{{F}_{n} ( f ) \cdot \text{?} ( f )}{\vert {F}_{n} ( f ) \cdot \text{?} ( f ) \vert} \qquad \# ( 1 )$$

$$\text{?} \text{indicates text missing or illegible when filed}$$

where
the operator ‘*’ indicates complex conjugation;
the index ‘n’ is used to show time position, with n the WOLA sample from the current WOLA analysis frame and (n−Δ) indicates a WOLA sample in the same frequency bin, but from a previous WOLA analysis frame (ending Δ WOLA blocks ago, where Δ is a positive integer) in the WOLA domain;
the index ‘f’ is the frequency bin (subband) of the WOLA samples. In the example where there are 33 subbands, f takes on integer indices 1-31, which represent frequency bins each having an equal frequency bandwidth, except for the first and last subbands. Fora non-limiting example, there may be 33 subbands, with the 1^{st} through 31^{st} subbands each having a bandwidth 250 Hz, and the 0^{th} and 32^{nd} subbands each being a half band (0 to 125 Hz) and (7875 to 8000 Hz), respectively. For example, f=4 indicates frequency bin centered at 4*250=1000 Hz and ranging from 875 Hz to 1125 Hz. Because the 0^{th} and 32^{nd} bins are half bands and are always Real, they are not processed to detect for tones. However, in other examples, the number of bins can be an even number, with all bins having the same bandwidth and all bins being processed to detect for tones;
Fₙ(f) is the complex time-frequency sample at bin of frequency f at WOLA time index n; and
NormCorₙ(f) is the normalized cross-correlation calculated between the two WOLA samples.

In selecting WOLA samples for carrying out the calculations in equation (1), Δ is typically chosen such that there is no overlap between the WOLA analysis frames in the time domain, (as overlap would have the potential to bias the correlation metric), but not so large that it could potentially delay the detection time. Choosing Δ such that the older WOLA analysis frame finishes before the current WOLA analysis frame starts is one currently preferred technique for selecting Δ, although other values for Δ may be implemented alternatively. In general, it is preferred (although not necessary) that the WOLA analysis frames are selected to that the samples selected from them for comparison calculations do not overlap in time, so that the old WOLA analysis frame finishes at least one time sample before the time samples used to generate the WOLA blocks for the current WOLA analysis frame.

Equation 1 can be written equivalently as equation (2) as follows:

$${NormCorr}_{n} ( f ) = {e}^{i π [ arg ( {F}_{n} ( f ) ) - arg ( {F}_{n - Δ} ( f ) ) ]} \qquad \# ( 2 )$$

Although equation (2) is equivalent to equation (1), equation (2) is much more complicated to calculate than equation (1), so it is not calculated by the present invention during use, but is presented here for illustrative purposes only. Equation (2) shows that the NormCorₙ(f) metric is effectively a complex value with unity magnitude and with phase equal to the phase difference between the WOLA samples from the two WOLA analysis frames. It is noted that a tone will have a fixed phase difference across WOLA samples. Therefore a tone (with just a small amount of noise), when processed as described herein, will result in normalized correlation values with consistent phase. The correlation measured by the correlation calculations described herein measure the correlation of a signal over time. The calculations are performed each on a subband of the input signal, comparing two different WOLA samples in the same subband that occur at different times. The measurement then determines how similar the two different WOLA samples are, i.e., their correlation value, to detect whether a tone is present in that particular subband for which the calculations are performed. The calculations can be performed similarly for each subband, each subband having its own cross-correlation computation. Iterations of the calculations, each for a pair of WOLA samples of a particular subband across multiple times can be calculated.

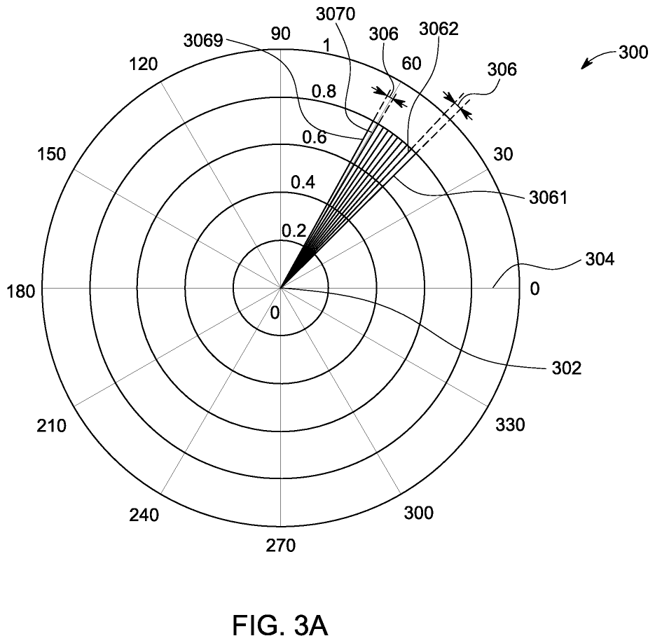

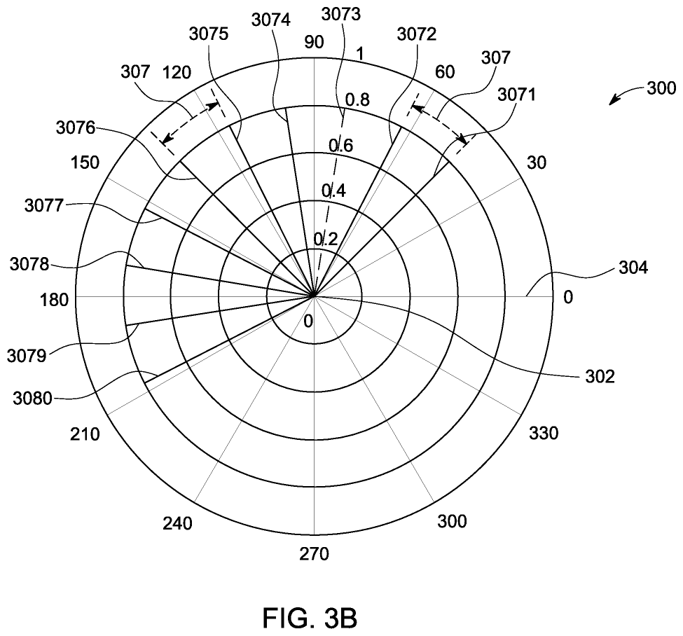

The complex results from the WOLA within each frequency subband represent the magnitude and phase of the signal in the frequency subband at a given point in time. These complex-valued results created for each WOLA analysis frame or block of data can be analyzed over time by comparison to one another (using NormCorr) to detect the presence of a tone, as already described. For example, FIG. 3A shows complex results calculated from the WOLA at ten evenly spaced points in time for a particular subband. The complex WOLA samples are plotted as polar coordinates on chart 300 as reference numerals 3061 through 3070 (although not all of the successive reference numerals are shown in FIG. 3A, for simplicity), with the radial distance from the origin 302 representing the magnitude of the complex WOLA Analysis and the angle from the reference direction 304 representing the phase of the WOLA Analysis. The values plotted are the raw WOLA analysis results for a single bin. Because these are raw values, and not normalized cross-correlation values, they do not necessarily have a magnitude of one and do not have a magnitude of one in FIG. 3A, for example. The plot shows how the vector rotates over time at a constant rate. The Norm Cross Corr gives a measure of the rate of change between two WOLA analysis frames.

The complex results of the WOLA analysis for a subband vary over time depending upon how close the frequency of the signal being processed is to the subband frequency center. For example, FIG. 3A shows complex results 3061-3070 from ten uniformly spaced WOLA samples from a subband having a frequency center of 2,000 Hz, with the subband ranging from 1,875 Hz to 2,125 Hz. The tone being analyzed by the calculations for FIG. 3A had a frequency of 2,010 Hz. As a result, it can be seen that the spacing 306 between adjacent complex results values is relatively small. In contrast FIG. 3B shows complex results 3071-3080 from ten uniformly spaced WOLA samples from a subband having a frequency center of 2,000 Hz, with the subband ranging from 1,875 Hz to 2,125 Hz, where the tone being analyzed by the calculations for FIG. 3B had a frequency of 2,100 Hz. As a result, it can be seen that the spacing 307 between adjacent complex results values is larger, relative to the spacing 306.

However, in both cases, it can be observed that the signal that is being analyzed is tonal. This is because the spacings 307 are all equal to one another in FIG. 3B (i.e., spacing 307 between 3071 and 3072 is equal to the spacing 307 between 3075 and 3076 and is equal to the spacing 307 between each pair of adjacent values ranging from 3071 to 3080). Likewise the spacings 306 are all equal to one another in FIG. 3A (i.e., spacing 306 between 3061 and 3062 is equal to the spacing 306 between 3069 and 3070 and is equal to the spacing 306 between each pair of adjacent values ranging from 3061 to 3070). That is, in both FIGS. 3A and 3B it can be observed that the phase of the complex result changes at a constant rate over time as shown by the equal spacings (306, 307, respectively) between successive WOLA complex analysis results. This is indicative of a tone. The rate of change is different for these two examples (FIG. 3A and FIG. 3B) as evidenced by distance 307 being significantly greater than the distance 306 and is related to how far from the subband frequency center the tone is. As noted, the complex results from the calculations described herein do not require the calculation of the phase angle of complex FFT values directly, nor the derivation of the rate of change of phase angle. Such calculations typically require calculations such as the arctangent, which are difficult and time consuming to perform on an embedded fixed-point digital signal processing (DSP) platform. The present invention does not require the calculation of the phase angle directly, and provides a more efficient, less computationally intensive solution for detecting tonality. The present invention calculates the normalized cross-correlation between WOLA samples of a frequency subband at the current or a first time and at an older or previous time, in the same frequency subband to provide a metric that represents the consistency of phase changes over time. The calculation includes a complex multiplication, followed by the division of the product by its magnitude.

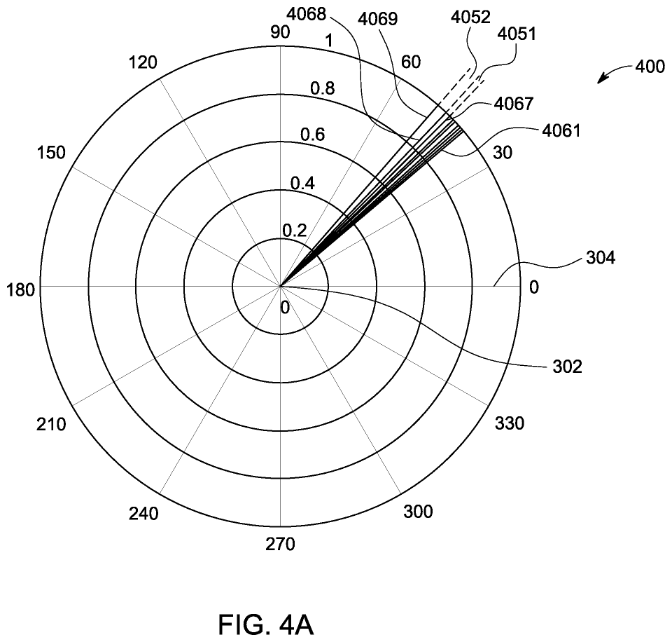

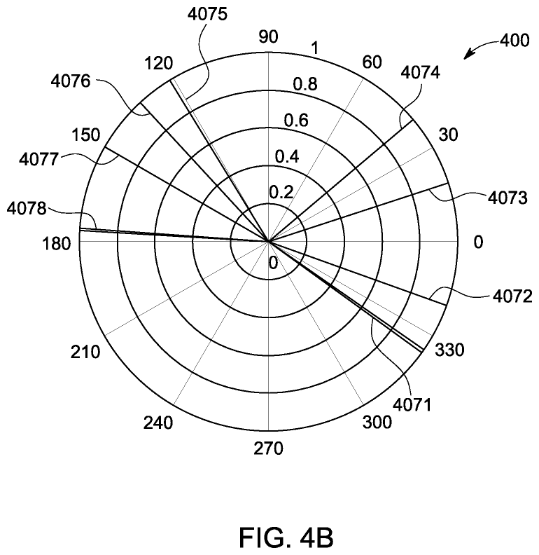

As discussed in the previous section, a tone will have a fixed phase difference across frames, therefore a tone (with just a small amount of noise) will result in normalized correlation values with consistent phase, like those in plot 400 of FIG. 4A. FIG. 4A shows that each of the plotted complex correlation results 4061-4069 has about the same phase value, (around 45° in this example) indicating that the signal being analyzed is a tone. Although the spacings between adjacent value plots are not all exactly equal (e.g., space 4052 between 4068 and 4069 is greater than space 4051 between 4067 and 4068), the differences are small and are attributable to noise. Although there really isn't a predetermined dividing line as to when the spacing shows tones with noise, versus when the spacing differences are great enough to show that the signal is not tonal (a threshold valued is used to which Norm_Cross_Corr is compared to make such a determination, as described in detail below), a tone with noise will typically have the phases of the successive complex analysis results all within about a 90-degree arc when plotted. A non-tonal input will have random phase like in FIG. 4B. FIG. 4B is a plot 400 that shows that the plotted complex correlation results 4061-4070 have greatly varying phase angles. For example, 4073 has a phase angle around 20°, 4075 has a phase angle that is a little over 120° and 4078 has a phase angle that is nearly 180°. The phase angles are spread out randomly across the results, indicating that the signal being analyzed is not tonal. Likewise, the spacings between the plotted results 4071-4078 vary greatly and indicate non-tonality.

The average (complex) value over several WOLA samples for the tonal input in FIG. 4A is close to one, while the average (complex) value for the non-tonal input in FIG. 4B is close to zero. These are the magnitudes of the complex average. The complex average value is the sum of all of the real parts divided by the number of complex values, and the sum of the imaginary parts divided by the number of complex values to give the average real component and average imaginary component. Both the real and imaginary parts will average zero for a non-tonal input. The average (complex) value can be approximated by introducing a smoothing factor to the normalized cross-correlation (calculated in equation (1)), with the smoothing factor being applied as shown in equation (3):

$${NormCorr}_{n}^{smth} ( f ) - {NormCorr}_{n - 1}^{smth} ( f ) + α \cdot ( {NormCorr}_{n} ( f ) - {NormCorr}_{n - 1}^{smth} ( f ) ) \qquad \# ( 3 )$$

where
NormCorrₙ(f) is the normalized cross-correlation calculated between the two WOLA samples (see equation (1);
NormCorrₙ^{smth}(f) is the average or smoothed cross-correlation value; and α is a smoothing factor.

The value of a is selected to be small, for example 0.02, but may vary over a large range of values, typically from about 0.01 to 1.0, but the range could be extended at either or both ends The preferred value may also vary depending upon the sampling rate of the time frames. As an alternative to being a decimal value as described, α could be implemented as a right shift if α is a negative power of two.

Once smoothing has been applied as in equation (3), a metric for detecting tonality can be calculated. Equation (4) shows the metric, which is simply the magnitude (absolute value) of the smoothed, normalized cross-correlation.

$${Metric}_{n} ( f ) = \vert {NormCorr}_{n}^{smth} ( f ) \vert \qquad \# ( 4 )$$

This metric can be compared to a predetermined threshold to decide whether a tone is present. In one embodiment, this threshold is chosen to be 0.6, although this value may vary. For example, a predetermined threshold value may be set to have a value selected from the range from 0 to 1, typically within the range from 0.2 to 0.8.

Approximation techniques can be used to still further increase the efficiency of tone detection processing according to an embodiment of the present invention. For example, the numerator of equation (1) can be implemented with efficient multiplies and additions, as shown in equations (5) and (6):

$$Num - ( {R}_{n} + {I}_{n} \cdot i ) \cdot ( {R}_{n - Δ} - {I}_{n - Δ} \cdot i ) \qquad \# ( 5 )$$

where
Rₙ is the real component of Fₙ,
Iₙ is the imaginary component of Fₙ,
R_{n-Δ} is the real component of F_{n-Δ}, and
I_{n-Δ} is the imaginary component of F_{n-Δ}.

Rearranging gives:

$$Num = ( {R}_{n} \cdot {R}_{n - Δ} + {I}_{n} \cdot {I}_{n - Δ} ) + ( {R}_{n - Δ} \cdot {I}_{n} - {R}_{n} \cdot {I}_{n - Δ} ) \cdot i \qquad \# ( 6 )$$

The approximation for the denominator of equation (1) is more difficult to perform. As shown in equation (7) below, it is noted that a square root operation and a divide operation are required. In an embedded DSP processor, these operations are typically not supported directly in hardware or in the instruction set, so these operations can take many cycles each to execute. This compares poorly with the multiplies and adds required for the numerator, which are typically supported in hardware and take a single cycle to execute (or less where multiple multiply/add operations are available per instruction).

$$NormCorr = \frac{Num}{\sqrt{{Num}_{re}^{2} + {Num}_{im}^{2}}} \qquad \# ( 7 )$$

where
Num²ᵣₑ is the real component of Num (from equation (6)) squared, and Num²ᵢₘ is the imaginary component of Num (from equation (6)) squared.

DSP processors usually support a logarithm base 2 (log 2) approximation which can be utilized to make the implementation more efficient. This approximation has several names, CSB (count sign bits), CLB (count leading bits) and LOG 2ABS (log₂ approximation of absolute value) amongst others. The approximation usually executes in a single cycle and returns the number of leading sign bits for use in normalizing a fractional number to the magnitude range 0.5 to 1.0. In this case, we also need to account for the square root, but that is easily done by dividing the CSB result by 2 (i.e. shifting right by 1 bit) as shown in equation (8) below.

$$NormCorr = Num ≪ [ CSB ( {Num}_{re}^{2} + {Num}_{im}^{2} ) ≫ 1 ] \qquad \# ( 8 )$$

Depending on the implementation of CSB on the processor a further scaling value can be applied to the result to ensure that there is no bias in the error introduced to NormCorr. Although the error introduced here can be quite big, it will on average be zero. If the smoothing in equation (3) is slow enough, it will have minimal effect on the behavior of the algorithm. In at least one example, a scaling value of 0.02 was used.

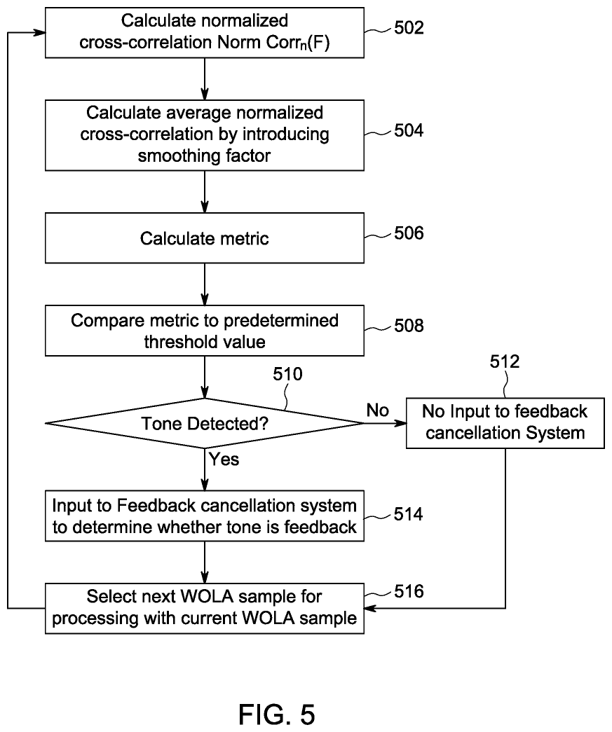

FIG. 5 is a flow diagram illustrating events that may be carried out during processing of a signal to detect whether there is tonality, according to an embodiment of the present invention. After processing an audio signal to break its frequency bandwidth into multiple frequency subbands, such as by WOLA frequency analysis and for each subband, forming blocks or frames of time-frequency domain data, wherein each frame or block of time-frequency domain data is formed by combining N samples of time-domain data, wherein N is a positive integer, typically greater than one (e.g., 8, in at least one embodiment) the blocks of data are then processed to detect whether tonality exists. This processing is done on a subband basis, so that WOLA samples that are compared are always from the same subband and are compared from WOLA analysis frames that do not have overlap. The WOLA samples may be from successive WOLA analysis frames in time, or may be separated by one or more WOLA blocks (and hence A WOLA samples). The processing is typically performed on a subband basis, for all subbands that the signal has been broken down into. However, this is not absolutely necessary, as a subset less than the total number of subbands could be processed, if desired, to further reduce processing power requirements. The comparison of WOLA samples can be iteratively and successively processed continuously to monitor signals for detection of tonality. Each successive WOLA analysis frame may be used for comparison, or alternatively, every second or third or Nth WOLA analysis frame may be compared, where N is a positive integer. However, it is more common and desirable to compare outputs from spaced WOLA analysis frames which result in complex WOLA samples spaced apart by A, such that each separate WOLA analysis frame has no time domain samples in common.

FIG. 5 illustrates processing that is carried out, on a subband basis, which is applicable to all subbands that are to be processed. This processing, as noted above, can be extended to successive WOLA samples within the same subband, and to pairs of WOLA samples and successive pairs of WOLA samples in any other subband (each subband having its own calculation). At event 502, a normalized cross-correlation is calculated between a pair of WOLA samples. The calculation of the normalized cross-correlation can be carried out using equation (1) above. At event 504 the average normalized cross-correlation value is calculated by introducing a smoothing factor as identified in equation (3) above.

After smoothing has been applied at event 504, a metric used for detecting whether tonality is present is calculated at event 506, such as by use of equation (4). The metric can then be compared to a predetermined threshold value at event 508 to determine whether or not tonality exists in the subband currently being processed. This processing can be carried out iteratively for continual monitoring, for the current subband as well as for all other subbands or subset of subbands.

Optionally, implementation of approximation techniques can be employed for calculation of normalized cross-correlation, as noted above. At event 510 the results of the comparison at event 508 determine whether or not a tone has been detected. If a tone has not been detected, then no changes are made to the current state of the feedback cancellation system based on the results of the comparison, see event 512. If a tone has been detected, then the WOLA samples used in calculating the metric are input to the feedback cancellation system in subsystem 140 for further processing to determine whether the tone is feedback or rather is a sound received from the environment. If the tone is determined to be from the environment, the feedback cancellation system will make no changes to its current state, based on this finding. If the tone is determined to be feedback, then the feedback cancellation system will make a change or changes to suppress the feedback tone. For example, the feedback cancellation system may reduce the gain of the signal in the subband where the tonal signal is detected to be feedback, and/or increase a cancellation adaptation rate to more rapidly cancel the feedback tone in the subband where detected. These actions can be carried out for a particular subband or for multiple subbands.

At event 516 the next block is selected for processing with the current block and the calculations resume for this new block pair at event 502.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for.

### Example 1

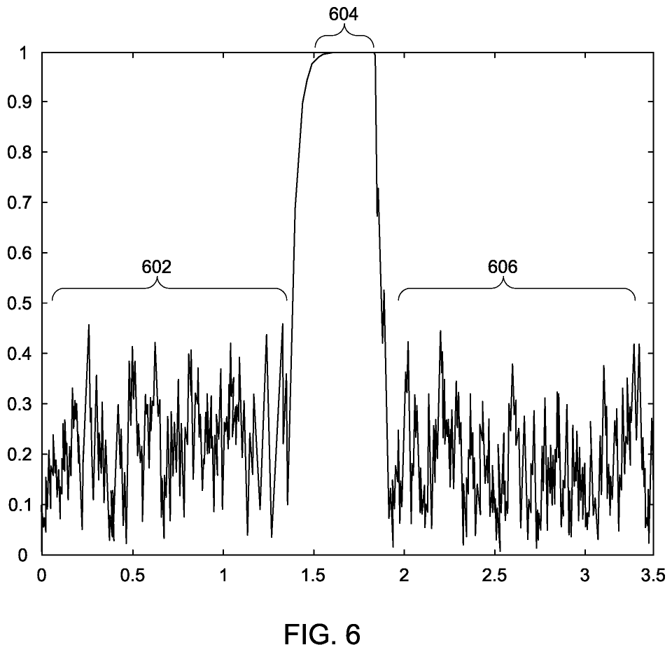

The response of the tone detector to a stimulus (signal) is shown in FIG. 6, according to an embodiment of the present invention. FIG. 6 plots the tone detector metric value on the y-axis versus time (in seconds) on the x-axis. The stimulus (signal) was an audio input of 3.5s duration of white noise with a 3 kHz tone having a duration of 0.5s starting at 1.4s. The audio input was processed using WOLA frequency analysis to decimate time frames and separate them into 33 non-overlapping frequency subbands centered at increments of 250 Hz. Eight samples of time-domain data were combined into a WOLA block and eight WOLA blocks were concatenated to form a WOLA analysis frame. The time-domain data was sampled at a 16 kHz sampling rate, with WOLA blocks being processed as a 2 KHz rate (i.e., once every 0.5 ms), and 64 point windows of 4 ms duration were used for FFT. Time sample overlap was 56/64 per WOLA analysis frame. The tone detector metric is low (i.e., less than the predetermined threshold of 0.6) during the time intervals 602 and 606 during which only white noise is present without the 3 kHz tone. During the time interval 604 when the 3 KHz tone is present with the white noise (i.e., from about 1.4 sec to 1.9 sec) the tone detector metric value spike above the predetermined threshold of 0.6 and up to a value of 1, and then return again sometime between 1.9 and 2 seconds to a value less than 0.6. Thus, the tone detector rapidly and reliably showed when a tone was present and when it was not.

### Examples 2-10

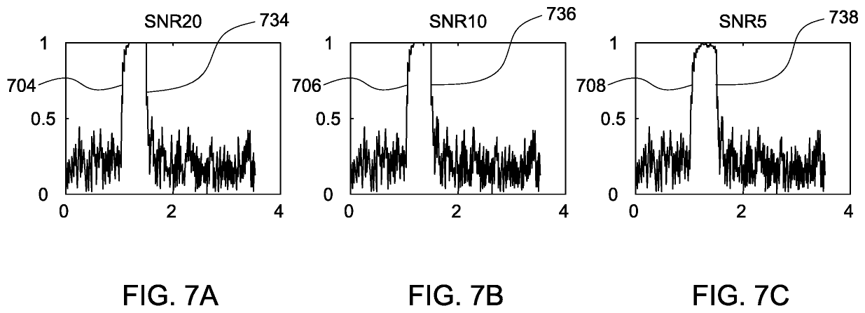

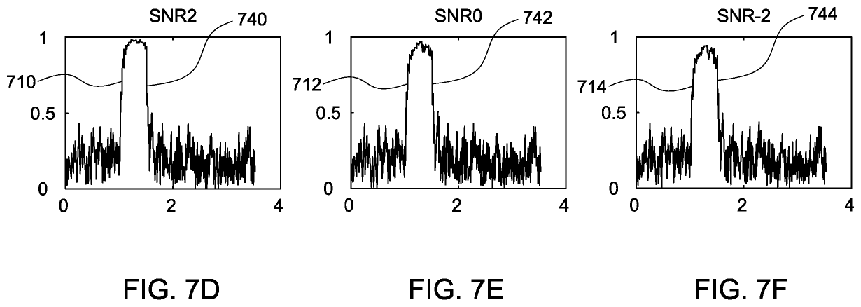

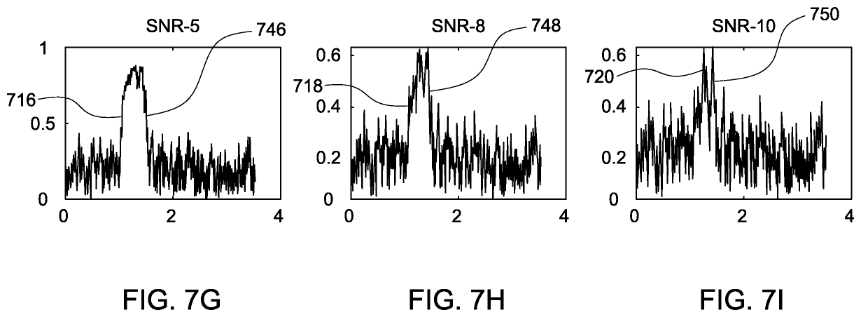

Examples 2-10 show in FIGS. 7A-7I, respectively, tone detector responses for audio inputs having different signal-to-noise ratio (SNR) of tone to noise. Each of Examples 2-10 was carried out exactly the same as described above with regard to Example 1, except for the only difference being the SNR of the 3 KHz tone to the white noise. The SNR in Example 1 was 33 dB. Example 2 (FIG. 7A) used a SNR of 20 dB, Example 3 (FIG. 7B) used a SNR of 10 dB, Example 4 (FIG. 7C) used a SNR of 5 dB, Example 5 (FIG. 7D) used a SNR of 2 dB, Example 6 (FIG. 7E) used a SNR of 0 dB, Example 7 (FIG. 7F) used a SNR of-2 dB, Example 8 (FIG. 7G) used a SNR of 5 dB, Example 9 (FIG. 7H) used a SNR of-8 dB and Example 10 (FIG. 7I) used a SNR of −10 dB. In each example, the tone detector responded strongly and rapidly above the 0.6 threshold value to indicate when the tone was present, see 704, 706, 708, 710, 712, 714, 716, 718 and 720, respectively, rapidly returned below the threshold value after cessation of the tone, see 723, 736, 738, 740, 742, 744, 746, 748 and 750, respectively.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

1. A method of signal processing an audio signal in a hearing device to determine whether the signal is tonal, the method comprising:
converting the signal at each of a series of successive time windows into samples in the frequency domain across multiple subbands;
calculating for at least one of the subbands a normalized cross-correlation between two different samples in the same subband; and
comparing a metric resulting from said calculating to a predetermined threshold to provide a measure of whether the signal is tonal;
wherein the signal is considered to be tonal in the frequency of the subband when the metric is greater than or equal to the predetermined threshold and the signal is considered to be not tonal in the frequency of the subband when the metric is less than the predetermined threshold.

2. The method of claim 1, wherein said calculating and comparing are performed for each of a plurality of the multiple subbands.

3. The method of claim 1, wherein said calculating and comparing are performed for all of said multiple subbands.

4. The method of claim 1, wherein said calculating step is iterated for successive samples, and wherein said comparing step is performed relative to an average of the results from the iterated calculation steps.

5. The method of claim 1, wherein there is no time overlap corresponding to the two different samples in the frequency or joint time-frequency domain.

6. The method of claim 1, comprising improving processing efficiency of said calculating step by using at least one of count sign bits (CSB), count leading bits (CLB) or log₂ approximation of absolute value.

7. The method of claim 1, wherein when a signal is considered to be tonal, said method further comprises:
reducing a gain of the signal in the subband where the tonal signal is considered to be.

8. The method of claim 1, wherein when a signal is considered to be tonal, said method further comprises:
providing the tonal signal to a feedback cancellation system configured to determine whether the tonal signal is feedback.

9. The method of claim 1, wherein the hearing device is a hearing aid.

10. The method of claim 9, wherein the hearing aid is a completely-in-the-canal (CIC) hearing aid.

11. A hearing device, comprising:
a microphone;
a receiver; and
a processor connected to said microphone and said receiver, said processor configured to receive an audio signal from said microphone and process the audio signal and said receiver configured to provide an output signal to a user, the processor further configured to:
convert the signal at each of a series of successive time windows into samples in the frequency domain across multiple subbands;
calculate for at least one of the subbands a normalized cross-correlation between two different samples in the same subband; and
compare a metric resulting from the calculation of the normalized cross-correlation to a predetermined threshold to provide a measure of whether the signal is tonal;
wherein the signal is considered to be tonal in the frequency of the subband when the metric is greater than or equal to the predetermined threshold and the signal is considered to be not tonal in the frequency of the subband when the metric is less than the predetermined threshold.

12. The hearing device of claim 11, wherein the hearing device is a hearing aid.

13. The hearing device of claim 12, wherein the hearing aid is a completely-in-the-canal (CIC) hearing aid.

14. The hearing device of claim 11, wherein
when a signal is considered to be tonal, said signal is provided for further processing to determine whether the tonal signal is feedback; and
when the tonal signal is determined to be feedback, reduce a gain of the signal in the subband where the tonal signal is considered to be.

15. The hearing device of claim 11,
wherein when a signal is considered to be tonal, said signal is provided for further processing to
determine whether the tonal signal is feedback, so that when the tonal signal is determined to be feedback, the feedback can be addressed by a feedback cancellation system to cancel the feedback.

16. The hearing device of claim 11, wherein said processor is configured to perform said calculate and compare steps for each of a plurality of the multiple subbands.

17. The hearing device of claim 11, wherein said processor is configured to perform said calculate and compare steps for all of said multiple subbands.

18. The hearing device of claim 11, wherein said calculate step is iterated for successive samples, and wherein said compare step is performed relative to an average of the results from the iterated calculation steps.

19. The hearing device of claim 11, wherein said processor is configured to improving processing efficiency of said calculate step by using at least one of count sign bits (CSB), count leading bits (CLB) or log₂ approximation of absolute value.

20. A hearing device, comprising:
a microphone;
a receiver; and
a processor connected to said microphone and said receiver, said processor configured to receive an audio signal from said microphone and process the audio signal and said receiver configured to provide an output signal to a user, the processor further configured to:
convert the signal at each of a series of successive time windows into samples in the frequency domain across multiple subbands;
compare a pair of samples in the frequency domain in a same one of the subbands to calculate a normalized cross-correlation;
calculate a metric based on said normalize cross correlation and compare said metric to a predetermined threshold to provide a measure of whether the signal is tonal;
wherein the signal is considered to be tonal in the frequency of the subband when the metric is greater than or equal to the predetermined threshold and the signal is considered to be not tonal in the frequency of the subband when the metric is less than the predetermined threshold.
